(19) United States
(12) Patent Application Publication
(10) Pub. No.: US 2020/0408443 A1
(43) Pub. Date: Dec. 31, 2020

(54) DEVICE FOR TREATING AND HEATING WATER IN TANK STYLE WATER HEATERS

(71) Applicant: WATURU HOLDING APS, Vejle (DK)

(72) Inventor: Toke REEDTZ, Vejle (DK)

(73) Assignee: WATURU HOLDING APS, Vejle (DK)

(21) Appl. No.: 16/962,618

(22) PCT Filed: Jan. 17, 2019
(86) PCT No.: PCT/DK2019/050016

§ 371 Date: Jul. 16, 2020

(30) Foreign Application Priority Data
Jan. 18, 2018 (DK) PA 2018 00031

(51) Int. Cl. F24H 1/20; F24D 17/00; F24D 19/00; F24D 19/08; F24D 19/10; C02F 1/48

(52) U.S. Cl. CPC F24H 1/203; F24D 17/0073; F24D 19/0092; F24H 1/185; F24D 19/1051; F24D 17/0078; C02F 1/48; F24D 19/083

(57) ABSTRACT

A system containing a device mounted to the flange of a tank style water heater while being connected to a AC power-source and thereby treating and heating the water, within a passage between electrodes in a core, simultaneously delivering bacteria free warm or hot improved water without limescale issues and being 20% to 30% more energy efficient. Furthermore, a method is describe using a pump to deliver the water to the device in connection with a control solution.

The present invention relates to the use of a device mounted to the flange of a tank style water heater while being connected to a AC power source and thereby treating and heating the water simultaneously delivering bacteria free hot and improved water.

### BACKGROUND OF THE INVENTION

A hot water storage tank (also called a hot water tank, thermal storage tank, hot water thermal storage unit, heat storage tank and hot water cylinder) is a water tank used for storing hot water for space heating or domestic use.

Water is a convenient heat storage medium because it has a high specific heat capacity. This means, compared to other substances, it can store more heat per unit of weight. Water is non-toxic and low cost.

An efficiently insulated tank can retain stored heat for days, reducing fuel costs. Hot water tanks may have a built-in gas or oil burner system, electric immersion heater. Some types use an external heat exchanger such as a central heater system or heated water from another energy source. The most typical, in the domestic context, is a fossil-fuel burner, electric immersion elements, or a district heating scheme.

Water heaters for washing, bathing, or laundry have thermostat controls to regulate the temperature, in the range of 40 to 60° C. (104 to 140° F.), and are connected to the domestic cold water supply.

Where the local water supply has a high content of dissolved minerals such as limestone, heating the water causes the minerals to precipitate in the tank (scaling). A tank may develop leaks due to corrosion after only a few years, a problem exacerbated by dissolved oxygen in the water which accelerates corrosion of both tank and fittings.

Water heater tanks may be made of vitreous enamel-lined carbon steel, stainless steel, or copper.

While copper and stainless steel domestic hot water tanks are more commonplace in Europe, carbon steel tanks are more common in the United States, where typically the periodic check is neglected, the tank develops a leak whereupon the entire appliance is replaced. Even when neglected, carbon steel tanks tend to last for a few years more than their manufacturer's warranty, which is typically 3 to 12 years in the US.

Vitreous-lined tanks are much lower in initial cost, and often include one or more sacrificial anode rods designed to protect the tank from perforation caused by corrosion made necessary since chlorinated water is very corrosive to carbon steel. As it is very nearly impossible to apply any protective coating perfectly (without microscopic cracks or pinhole defects in the protective layer) manufacturers may recommend a periodic check of any sacrificial anode, replacing it when necessary.

Some manufacturers offer an extended warranty kit that includes a replacement anode rod. Because conventional hot water storage tanks can be expected to leak every 5 to 15 years, high-quality installations will include, and most US building/plumbing codes now require, a shallow metal or plastic pan to collect the seepage when it occurs.

When flow starts from the uppermost outlet, cold water enters the tank at the bottom. This drop in temperature causes the thermostat to switch on the electric heating element at the bottom of the tank. When the water at the top of the tank is drawn off the hot water at the top is displaced by relatively cooler water, the top thermostat turns the top element on. When the flow stops, the elements stay on until their settings are met.

While it is common to have the top and bottom thermostats set differently in order to save energy, the fact that hot water rises means the thermostat controlling the upper element should feed the hottest supply, while the lower element the warmest.

If the thermostats in such a system are reversed—warm feed from the top, hot from the center—it may not only affect the energy efficiency of the system, feeding scalding water to a domestic hot water outlet may be dangerous, or if directed to warm-feed washers damage them beyond repair.

Hot water can cause painful, dangerous scalding injuries, especially in children and the elderly.

Water at the outlet should not exceed 49 degrees Celsius. Some jurisdictions set a limit of 49 degrees on tank setpoint temperature. On the other hand, water stored below 60 degrees Celsius can permit the growth of bacteria, such as those that cause Legionnaire's disease, which is a particular danger to those with compromised immune systems. One technical solution would be use of mixing valves at outlets used for sinks, baths or showers, that would automatically mix cold water to maintain a maximum below 49 C. A proposal to add this to the building code of Canada was unsuccessful.

In WO 2012/011051 A1 is discloses a water heater for use for e.g. making hot water for human consumption. The water heater comprises a heating element which is configured to be in contact with the water to be heated. The water heater furthermore comprises a counter electrode which likewise is configured for being in contact with the water to be heated. An AC voltage is to be applied between the heating element and the counter electrode. A DC voltage of at least 0.5 V is furthermore to be applied between the heating element and the counter electrode in such a way that the heating element acts as a positive electrode. According to WO 2012/011051 A1 this design of the heating element implies reduced scaling. WO 2012/011051 A1 does not disclose inclusion in the water heater of a pump and therefore does not provide for fast heating of the water supplied thereto.

### BRIEF DESCRIPTION OF THE INVENTION

It is an object of the present invention to provide a solution to some of the issues of a traditional tank style electric water heater, with the use of a new device for treating, heating and improving the water in a tank style water heater.

The present invention relates to a system which can replace the current heat element or immersion heat element and deliver up to 30% faster hot water and thereby better efficiency on energy used to heat the water while simultaneously treating the water for any bacteria or spores in the tank and improving the structure of the water, thus causing lime scale to become dust like.

The invention only works with a pump supplying the device with water and not like a traditionally electric tank water heater where the water itself as the temperature raises moves to the top of the tank.

The invention furthermore makes it possible to set the temperature to warm or lukewarm water ex. 35-40 degrees C. without having to deal with increase in bacteria count and or Legionella and not being at risk of painful and dangerous scalding because the water in the device is treated by letting the water pass through electrodes which creates a field of AC power directly into the water.

Even further the device in connection with a pump circulates the water thus limiting still water in the tank and limiting even large tanks to one heating or treating source.

Even further it has been proven that the power can be contained within the device by having a non-conducting outlet of more than 2 cm thus the water in the tank is not electrified at all times which again would be a problem especially with tank of a conducting material.

In an embodiment of the invention, the device including a pump is mounted on the flange and the improvement of the water as a benefit to treating or heating it creates an environment where the anode is no longer needed as there will not be any corrosion and furthermore the thermostat is built into the device.

One aspect of the invention, relates to a method for heating and treating the water where the device while electrifying the water in the device itself will not leave the device and thus causing the water in the tank to become electric conductive at the risk of any touching the tank or tank setup and while not triggering the HIFI—circuit breaker.

In another embodiment the system and device can be fitted to any tank style water heater with a flange with a diameter of more than 30 mm.

In another embodiment the device has the ability to change effect e.g. 500 Watt 1500 Watt or more without having to empty the tank of water and change the heat element or immersion heater as you would normally have to do.

In another embodiment the system works in relation with a valve that has the ability to release any hydrogen created in the process of treating or heating the water.

### THE DRAWINGS

In the following, an exemplary embodiment of the invention is described in more detail with reference to the drawing, of which

FIG. 1 illustrates a flange with the system consisting of a device and a pump and non conduction outlet.

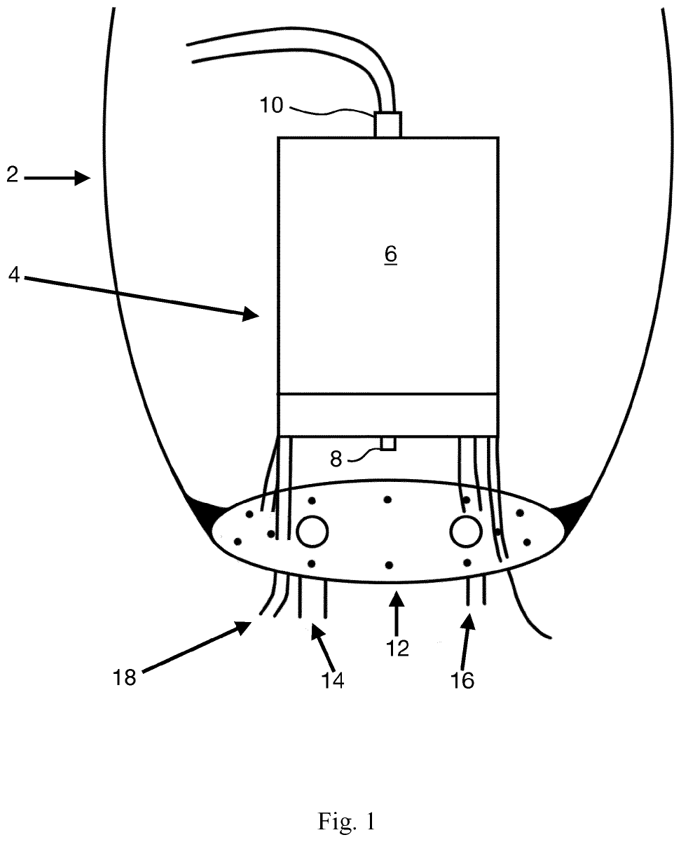

FIG. 2 illustrates a tank with the device inside

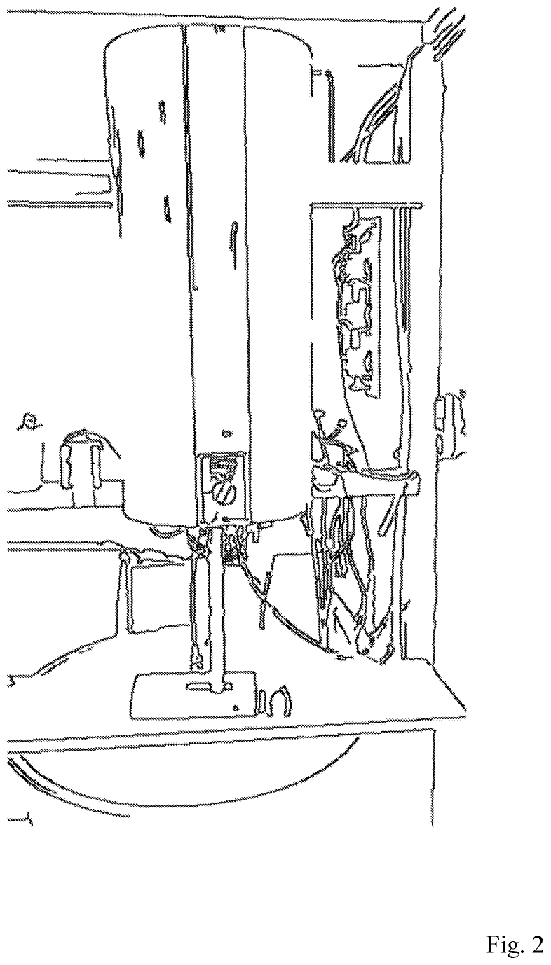

FIG. 3 Shows results from treating raw river water from Beijing with the device

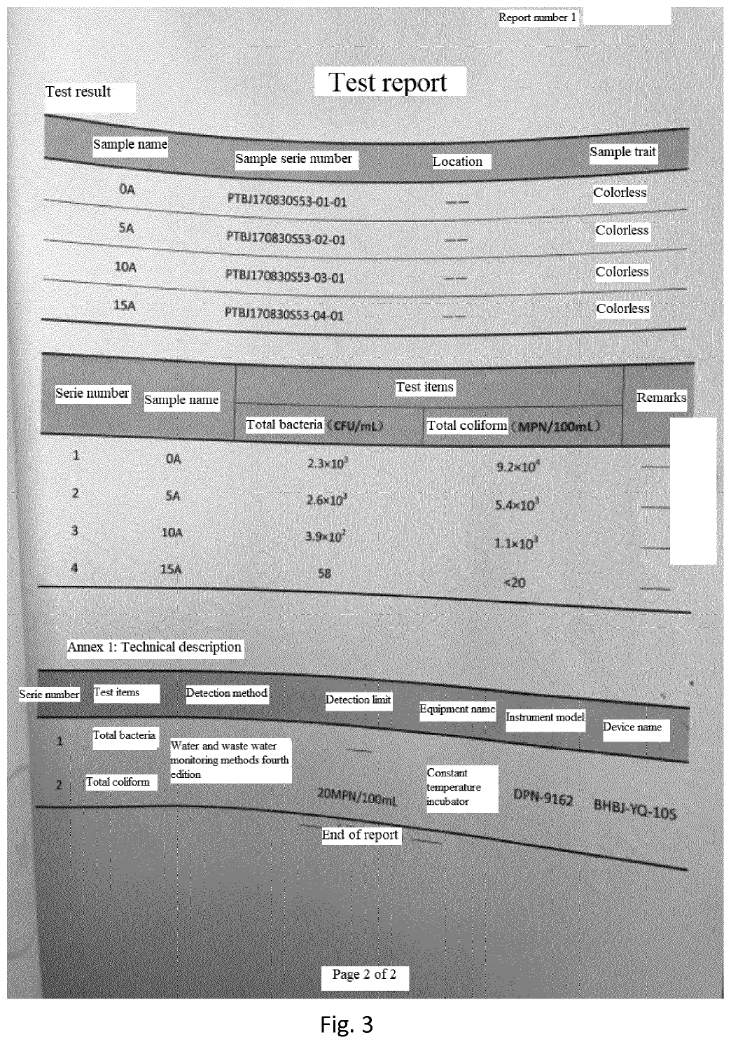

FIG. 4 Shows efficiency using TC-08 USB thermocouple data equipment in relation with type k—exposed wire thermocouple.

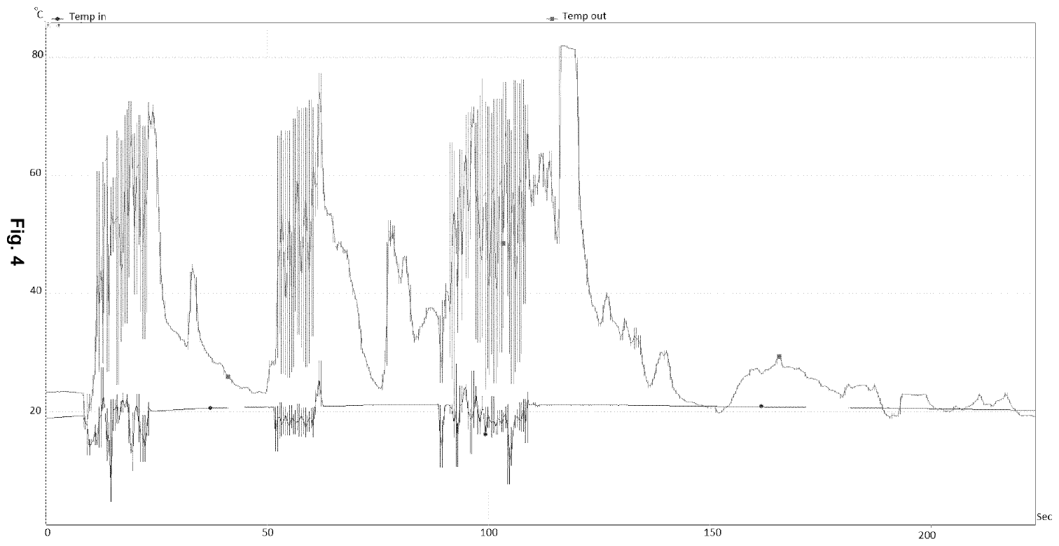

### DETAILED DESCRIPTION OF THE INVENTION

A new system for achieving better energy efficiency, better user comfort with faster and cleaner water and avoid many of the traditionally issues in electric tank style water heaters is presented.

The many current risks of traditionally electric tank style water heater among other 1) having to heat the water to scalding temperature to avoid Legionella or other bacteria 2) low energy efficiency, 3) high maintenance due to limescale issues and consequently broken immersion heater/heat element 4) a long waiting time for heating the water after a shut off period or when the tanks volume of hot water is used are being solved with the present invention which makes use of a new type of heating and treating of water using AC power to directly electrify water. The new type of heating and treating as a technology has been used within the tank less segment of water heating but not within the tank style segment. This latter due to the fact that it has been considered that a traditionally heat element inside a tank is very efficient as the heat or watts used can only go into the water but mostly because of the problem of electrifying the tank and water leaving the tank itself.

The system presented consists of a small pump in connection with the inlet of a device which leads water in between electrodes of graphite in such a way that the water flow passing the electrodes sees no water being held back which would otherwise cause a build-up of dust like lime scale on the area of the electrodes with still like water. The water leaves the device via an outlet that is of non-conducting material. This has shown the unexpected option namely to use this technology and described device to heat and treat water in a traditionally electric tank style water heater where the heat element has been replaced due to fault or because of a request of better comfort or higher energy efficiency and not electrifying the tank or water itself.

The outlet and inlet is made via a pushin solution using 6-14 mm lldpe tubing. The outlet can be adjusted to deliver the water close to the tank outlet and thus the solution would increase the comfort for the user in bringing down the waiting time for hot water.

The system is mounted on a flange that fits the current tanks from different manufactures in a way that the device and pump is encapsulated so that the AC power which is connected to 1) the one side of the device holding the phase electrodes and 2) the other side of the device holding the neutral electrode. Furthermore, multiple wires connecting to a thermocouple or thermostat and power for the small pump delivering the water to the device. The wires have no contact with the water in the tank thus not triggering the circuit breaker.

To encapsulate the device and pump a pom material is used to design a rocket take off like platform where 4 legs creates room between the system and the flange and where the inlet water is sucked up through the pump and in to the device and then to finally leave the device through the special outlet.

The solution makes it possible to run the water at a lower temperature and not run into issues with built up of bacteria or Legionella because the electric field within the device kills all bacteria at a minimum from 3000 watts and up at 230 V. This ability to disinfect has been described by being a result of electrons set in motion from when the electrodes shift from − to + with increased speed at higher amps and higher volts. This feature furthermore has the ability to kill spore like Cryptosporidium which are chlorine resistant.

Testing the system has shown a huge increase in efficiency and improved comfort. In a test setup using a Metrotherm electric tank with a capacity of 60 liters, Kamstrup measuring equipment and secondary a TC-08 pico data logger using USB/pc with Type K exposed thermocouple wires results describe in the present invention was reached. First test run was done with the traditionally heat element in the tank at 230 V 1000 Watts. with a outlet temperature 170 of 50 degrees C. Having noted the time, the tank was disassembled and the device was retrofitted and a new test with same temperature cold water and output water was started. The result was approx. a 30% improvement in efficiency as the watts was kept at the same level but the new invention delivered the 50 degrees C. hot water much faster approx. 15 min. compared to approx. 1 hour using the traditionally heat element. Same result was reached at 3000 Watt level using 400 V to power the traditionally heat element but still only 230 V to power the device hence the scalability of the new technology.

During the test it became clear that the system has to be able to fit different flange sizes and that the device would not have the same output when run without a pump supplying the water thus is was determined that a system without a pump would not work in real life use.

The current flange normally features an anode with keeps the tank from deteriorating or corrode. Normally this anode is made of magnesium, aluminum or zinc. Highly unexpected is was discovered that the system could run without the anode and still no signs of deterioration or corrosion was seen inspecting the tank after extensive tests. The results could be due to the fact that the water changes when being electrified in an abundance of hydrogen H+ that could create a defense against the oxidation process of rust.

The normal process can be explained as such:

Iron+water+oxygen→rust

4Fe(s)+6H2O(l)+3O2(g)→4Fe(OH)3(s)4Fe(s)+6HX2O(l)+3OX2(g)→4Fe(OH)X3(s)

Iron(III) hydroxide, Fe(OH)3Fe(OH)X3 then dehydrates to produce Fe2O3.nH2O(s)FeX2OX3.nHX2O(s) or rust

This anti rust solution could be especially important in water tanks where they normally lead to leaks and finally replacement of the tank damaging the environment and the water until final fail.

The controls needed to set the temperature or to make sure no bacteria is present in the water is connected to the system via wires running from the outside of the flange, through it, and through canals in the pom structure which holds the pump and the device. A light is turned on when the necessary watts to disinfect the water is reached making it possible for the user to feel safer using the water for bathing or other use.

The present invention has shown the unexpected effect of being much more efficient in heating the water with approx. 30% improvement compared to traditionally heat elements.

The present invention has also shown the unexpected effect of treating the water to a disinfection level thus enabling the user to turn the temperature down to ex. 40 degrees C. and not having bacteria built up inside.

The present invention has furthermore shown the unexpected effect of being able to electrify the water in the tank without electrifying the tank or the volume it holds itself, thereby erasing any risks of using the technology inside a tank style water heater instead of a traditionally heat element.

The present invention has even further shown the unexpected effect of limiting or fully remove the anode in the tank as the hydrogen production when electrifying the water in the device H+ defends the tank metal of the oxidations process of rust, thus delivering a much longer life expectancy of the tank compared to normal tanks with anodes. Also, the taste of the water is improved compared to traditionally tank style water heaters where rust and the anodes material is present in the water and water taste.

The present invention has even shown the unexpected effect of not being able to run without a pump supplying water to the device with holds electrodes that electrifies the water. This is surprising as the water would normally create a moving process due to the heating of the water itself as it happens in traditionally electric style water heaters.

The present invention has also shown the unexpected effect of being able to be turned on even without water in the tank, whereas a normal heat element would burn over.

The present invention has also shown the unexpected effect of being able to deliver hot water close to the tank outlet which is a wanted feature when the tanks it turned on from cold status e.g. secondary home but at the same time the invention has shown that it is not necessary with more than one heat source even if the tank is large in size as the water is moved around by the pump.

### LIST OF REFERENCE NUMERALS

2 Tank
4 System fitted to a flange in a tank
6 Device and pump
8 Inlet
10 Outlet
12 Flange
14 Tank inlet
16 Tank outlet

1. A system (4) for use within a tank style water heater; said system consisting of a pump and a device (6) for electrifying the water via AC powered electrodes; said system further comprises an electrically non-conducting outlet (16).

2. A system (4) according to claim 1, wherein the system is configured for being fitted to the flange (12) of a tank style water heater.

3. The system (4) according to claim 1, wherein the device and pump is being encapsulated in a non conducting material.

4. The system (4) according to claim 1, wherein no anode is fitted or configured to come into use.

5. The system (4) according to claim 1, wherein a valve is fitted to the tanks top to release any unwanted hydrogen.

6. A system (4) according to claim 1, wherein the device is configured for being supplied with power from an AC power source, based on a normal 110 V, 230 V or 400V.

7. A method for heating or treating water in a tank style water heater, so as to disinfect the water, run the tank safely at a lower temperature, by using AC powered electrode technology without electrifying the tank or the water inside the tank itself; and optionally further being able to achieve a anti rust environment without using an anode; said method comprises the steps of:
fitting a pump and a device (6) on the flange (12) of a tank style water heater in an electrically non-conducting material;
running the device and pump (6) on an AC power source e.g. 110V to 400V;
controlling the process based on temperature of the tank water, the tank outlet water or a disinfection level.

8. A method according to claim 7, wherein said method involves removing rust and corrosion in said tank style water heater.

9. A device consisting of pump, a flow sensor and a core; said core comprises electrodes configured to be connected to an AC power source and being encapsulated in an electrically non-conducting material; wherein said device thereby creates a passage for water to pass through said pump and sensor and between said electrodes in order to treat or heat said water.
